(19) United States
(12) Patent Application Publication
(10) Pub. No.: US 2004/0227336 A1
(43) Pub. Date: Nov. 18, 2004

(54) Data storage system for a vehicle occupant restraint system

(75) Inventor: Christian Agostini, Ruppertshofen (DE)

Correspondence Address: TAROLLI, SUNDHEIM, COVELL, TUMMINO & SZABO L.L.P., 1111 LEADER BLDG., 526 SUPERIOR AVENUE, CLEVELAND, OH, 44114-1400, US

(73) Assignee: TRW Automotive GmbH

(21) Appl. No.: 10/838,380

(22) Filed: May 4, 2004

(30) Foreign Application Priority Data
May 15, 2003 (DE) 103 21 935.8

(51) Int. Cl. G06F 7/00

(52) U.S. Cl. 280/735; 701/35

(57) ABSTRACT

A data storage system for storing specific information of a vehicle occupant restraint system comprises a connection plug connection. An electronic data memory is arranged in the vicinity of the connection plug connection of the vehicle occupant restraint system.

This invention relates to a data storage system for storing specific information in a vehicle occupant restraint system, for instance in an air bag module or a belt tensioner system.

### BACKGROUND OF THE INVENTION

Vehicle occupant restraint systems generally include a gas generator, which in the case of an air bag module deploys an air bag and in the case of a belt tensioner system adjusts a fitting part of the belt system or drives a belt reel of a belt retractor. Subsequently, reference is made to an air bag module for the sake of simplicity; the invention equally relates to other systems which use a gas generator.

The air bag module is incorporated for instance in a steering wheel of a motor vehicle. In the case of an accident of the vehicle, a propellant contained in the generator is ignited, whereby a gas pressure is generated and the air bag is inflated. After such a process, the air bag module is useless for further use in the vehicle occupant restraint system and must be replaced. When replacing the air bag module in the vehicle, care should be taken that a suitable replacement module is used, which can be integrated in the remaining components of the vehicle occupant restraint system and in existing vehicle electronics. Therefore, the air bag module must be identified with module-specific information such as manufacturer name, product name and possibly a test number. Such identification must be durable and unchangeable and in addition be freely accessible for reading out the information.

Air bag modules are known, in which module-specific information is printed as bar code on a self-adhesive label, which is adhered onto the module. During a stay in the workshop, for instance, such information is read out again by means of a suitable reading device. However, such bar code as information carrier includes substantial disadvantages. In this way, only small amounts of data can be stored, and when reading out the stored information by means of a reading device, reading errors occur quite often. As a result of the incorporation of the air bag module in the vehicle, the sticker bearing the bar code is frequently concealed by cladding parts, so that reading out the information is not possible without demounting the module.

It is therefore the object underlying the invention to provide a data storage system for storing specific information of a vehicle occupant restraint system, in which reading out the stored information in a simple way is always definitely possible without demounting the module or removing vehicle cladding parts.

### BRIEF DESCRIPTION OF THE INVENTION

In accordance with the invention, this object is solved in that an electronic data memory is disposed in the vicinity of the connection plug connection of the vehicle occupant restraint system. Thus, the system- or module-specific information is constantly kept ready in the vehicle and can be retrieved, if necessary, via the vehicle electronics, and for instance in the case of a stay in the workshop via a corresponding diagnostic unit. For this purpose, the data memory is connected with the vehicle electronics via a data line. Since reading out the module information in an electronic way is effected via this data line, the restraint module can remain installed in the vehicle. The installation of the module in the vehicle can be oriented to an optimum protection, as there is no necessity of a direct optical access to the module. When replacing the restraint module, the specific module information of the newly installed module is automatically forwarded to the vehicle electronics and checked by the same. It can thus be ensured that there is only used a module suitable for this vehicle. Moreover, the stored module information can be blocked against an unauthorized read-out of the data, whereby the module is secured against usage after a possible theft.

By the term connection plug connection the plug connection is meant which is used for connecting the vehicle occupant restraint system and usually consists of a socket and a plug associated to the socket.

As data memory, an EPROM is preferably provided, which due to the possibility of a very small size of about 1×1×0.3 mm can easily be arranged in the vicinity of the connection plug connection. However, the data memory can in principle consist of all known storage media, such as semiconductor memories, optical memories, capacitive memories and other known storage media.

In one embodiment of the invention, the data memory is integrated in the connection socket of the gas generator. In another embodiment of the invention, the data memory is integrated in the squib of the gas generator, and in a third embodiment of the invention, the data memory is integrated in the vehicle-side connector of the connection cable for the restraint module.

On the whole, all maintenance and repair processes concerning the restraint module can be simplified and accelerated distinctly by omitting the process of scanning all module data. In addition, safety is increased as regards an optimum integration of the module in a vehicle occupant restraint system.

Advantageous embodiments of the invention can be taken from the sub-claims.

### BRIEF DESCRIPTION OF THE DRAWINGS

The invention will now be described in detail with reference to drawings which represent various embodiments. In the drawings

FIG. 1 shows a sectional view of a gas generator for use in an air bag module;

FIG. 2 schematically shows a data storage system in accordance with the invention with data and ignition lines;

FIG. 3 schematically shows a data storage system in accordance with the invention with a data memory integrated in the connector of the connection cable; and

FIG. 4 schematically shows a data storage system in accordance with the invention with a data memory integrated in the squib of a gas generator.

### DETAILED DESCRIPTION OF THE INVENTION

The following description relates to an air bag module. However, the invention can equally be used in other vehicle occupant restraint systems which include a gas generator.

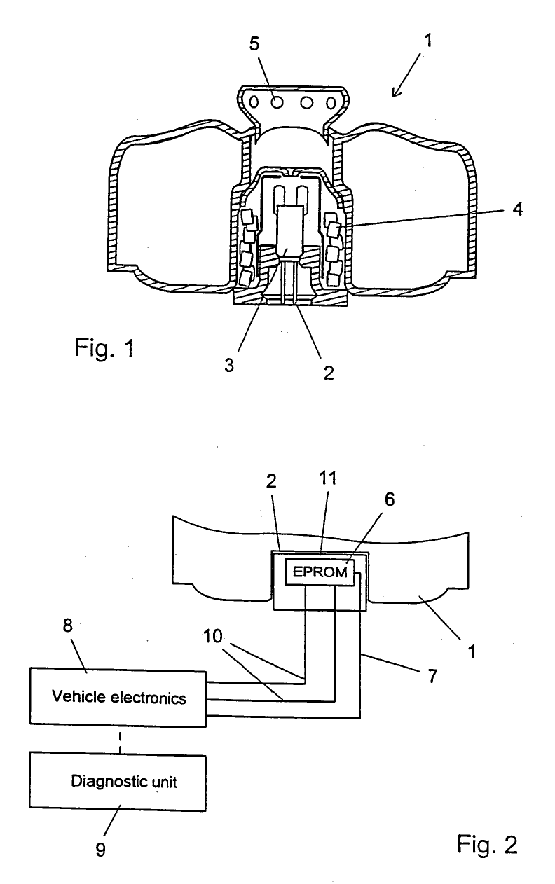

FIG. 1 shows a basically known embodiment of a gas generator 1 for an air bag module with a connection socket 2, a squib 3, propellant 4 and gas outlet openings 5.

FIG. 2 shows a connector 11 for connecting the gas generator 1, which is plugged into the connection socket 2. The connector 11 is connected to a vehicle electronics 8 and a diagnostic unit 9 via ignition lines 10. In this way, the gas generator can be activated if necessary in a manner known per se, in order to deploy an associated air bag.

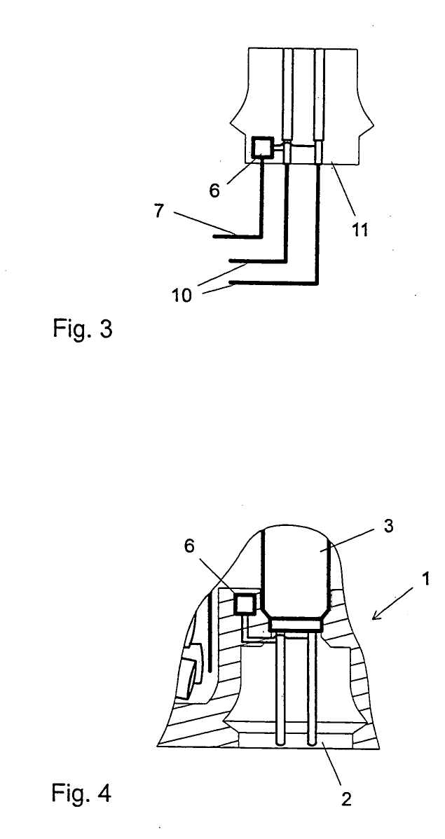

In the connector, there is integrated a data storage system with an EPROM as electronic data memory 6 (see also FIG. 3) which via a data line 7 is likewise connected with the vehicle electronics 8. The EPROM can be cast into the connector. Since the EPROM can be realized with very small dimensions of about 1×1×0.3 mm, such memory chip can easily be integrated in the connector 11.

For maintenance and repair purposes, a diagnostic unit 9 can be connected to the vehicle electronics 8, whereby the diagnostic unit 9 obtains access to the data of the data memory 6. Via the data line 7, data can be read out from the data memory 6, and for instance data concerning maintenance or repair can likewise be documented for future use and be stored in the memory.

In FIG. 4, an alternative embodiment is represented, in which the data memory is arranged in the socket in the gas generator and not in the connector. In this embodiment, the additional data line 7 is omitted, as the vehicle electronics 8 reads out the necessary data directly via the ignition lines 10.

The data memory might also be integrated in the squib 3 of the gas generator.

It may also be provided that a data memory is integrated both in the connector and in the connection socket. In this way, the compatibility between gas generator and vehicle electronics can be checked.

By reading out and evaluating the specific information of the air bag module, it can be ensured via a corresponding function of the vehicle electronics 8 that only an air bag module satisfying the specified requirements is used in the case of a possible replacement of the module. Moreover, in one embodiment an inventive data storage system is provided with a blocking function as regards the module information, which prevents a read-out of the data and thus an integration of the module in a vehicle occupant restraint system on certain conditions, for instance in the case of a missing or wrong access code. In the case of a theft of the air bag module, the same thus becomes useless for further use.

1. A data storage system for storing specific information of a vehicle occupant restraint system, comprising a connection plug connection, wherein in that an electronic data memory is arranged in said vicinity of said connection plug connection of said vehicle occupant restraint system.

2. The data storage system as claimed in claim 1, characterized in that a gas generator is provided and said data memory is integrated in a connection socket of said gas generator.

3. The data storage system as claimed in claim 1, characterized in that said data memory is integrated in a squib of said gas generator.

4. The data storage system as claimed in claim 1, characterized in that said data memory is integrated in a vehicle-side connector of said connection cable for said vehicle occupant restraint system.

5. The data storage system as claimed in claim 1, characterized in that said data memory includes an EPROM.

6. The data storage system as claimed in claim 1, characterized in that said data memory is connected with a vehicle electronics via a data line.

7. The data storage system as claimed in claim 1, characterized in that specific module information of said vehicle occupant restraint system is durably and non-erasably stored in said data memory.

8. The data storage system as claimed in claim 1, characterized in that stored specific module information of said vehicle occupant restraint system can be read out via a diagnostic unit without demounting said module.

9. The data storage system as claimed in claim 1, characterized in that in case of a replacement of said vehicle occupant restraint system stored specific module information is forwarded to a vehicle electronics for evaluation.

10. The data storage system as claimed in claim 1, characterized in that stored specific module information of said vehicle occupant restraint system can be blocked against a read-out of said data via a vehicle electronics.

11. The data storage system as claimed in claim 1, characterized in that stored specific module information of said vehicle occupant restraint system contains data with respect to effected workshop repairs.
